(19) United States
(12) Patent Application Publication
(10) Pub. No.: US 2017/0212917 A1
(43) Pub. Date: Jul. 27, 2017

(54) Online Social Networking System

(71) Applicant: Octavio Chiesa, Los Angeles, CA (US)

(72) Inventor: Octavio Chiesa, Los Angeles, CA (US)

(21) Appl. No.: 15/417,169

(22) Filed: Jan. 26, 2017

Related U.S. Application Data
(60) Provisional application No. 62/287,582, filed on Jan. 27, 2016.

(51) Int. Cl. G06F 17/30; H04L 29/08

(52) U.S. Cl. CPC G06F 17/30303; H04L 67/306; G06F 17/30312; G06F 3/0482

(57) ABSTRACT

A system and method for enabling users on an electronic social network to evaluate other users for purposes of establishing an affinity between the users prior to meeting. A plurality of candidate users individually create candidate user profiles and record candidate user recordings. A client user accesses an online media account to generate a client user subscription list. The candidate users also have subscription lists, and the database accesses and compares the subscription lists to create a sorted hierarchical list beginning with the closest matches. Client users view the recordings in order expresses interest or disinterest in candidate users by holding a key for a predetermined period. When a client user expresses disinterest, the database removes the candidate user profile and displays the next profile recording in order.

### RELATED APPLICATIONS

This application claims the benefit of the priority filing date of U.S. Provisional patent application Ser. No. 62/287,582, filed Jan. 27, 2016, which is incorporated here by reference in its entirety.

### BACKGROUND

Field of the Invention

The present invention generally relates to online social networking systems. More specifically, the present invention relates to systems used for facilitating relationship development between users incorporating selectable real-time video imaging and evaluation.

Related Art

The process of finding people with whom to form romantic relationships becomes difficult when one does not have time to meet and evaluate large numbers of people in person. Online dating platforms provide people with a more efficient way to meet large numbers of potential partners, but most of these platforms are based on text and video profiles, which do not allow users to communicate with one another nonverbally.

Psychological studies demonstrate that nonverbal communication is an essential component of any spoken message, and is particularly important when it comes to evaluating attraction between individuals; subtle variations in body language, tone of voice, and facial expression have an influence on the way any verbal message is interpreted. When the vast majority of online dating networks only allow users to express themselves to potential partners using still pictures and text, they are neglecting a fundamental aspect of attraction.

Some online dating services have incorporated real-time video calls into their platforms as a way of allowing users to express themselves nonverbally, but such solutions introduce a set of new issues. For example, these calls require users to be online and available to chat with one another at the same time, and this imposes a significant limitation on the number of exposures that such services can facilitate.

Hence, what is needed is a solution to the problems inherent in traditional text and photo-based online dating platforms that provides the capability for capturing non-verbal changes in body language, vocal tone, and facial expression, thus allowing use to observe non verbal cues of other users even when they are not online at the same time, without the limitations of existing online dating platforms.

### SUMMARY

In a first embodiment, the improvement disclosed herein is a method for enabling users of an electronic social network to evaluate other users for purposes of establishing an affinity between the users prior to meeting. The steps of the method include a plurality of candidate users individually creating a plurality of candidate user profiles. For each candidate user profile, a candidate user records a candidate user recording. Each of the plurality of candidate user recordings corresponds to one of the plurality of candidate user profiles.

A database associated with the social network is provided for storing the plurality of candidate user profiles and their corresponding recordings, A client user uses a computing device having a user interface, such as a computer or smart phone, to access the social network, thus being in communication with the database. The client user causes the database to access a separate online client user media account such as a YouTube® account. The client user media account includes information sufficient for generating a client user subscription list.

The candidate users also have media accounts such as YouTube® accounts, and those accounts are used to create candidate user subscription lists, in communication with the database. Thus each of a plurality of candidate user subscription lists associated with a candidate user, The database accesses the plurality of candidate user subscription lists, and compares the client user subscription list with each of the plurality of candidate user subscription lists, creating a sorted hierarchical list of the plurality of candidate user subscription lists ordered from a largest number of matches to a smallest number of matches of predetermined criteria.

The database also applies a filter to the hierarchical list, the filter identifying candidate user profiles for removal based on a predetermined criteria. The result is an exposure list that preserves the hierarchical order and stores the exposure list for later access by the client user through the computing device. When the client user accesses the social network, the client user is presented with an interface for displaying the recordings and the recordings are played back in order from the first recording in the hierarchically ordered exposure list.

The client user engages the computing device to access the exposure list (i.e., the ordered recordings) and expresses interest or disinterest in individual candidate users through the social media interface on the computing device. In one preferred embodiment, the client user expresses interest by holding a key associated with the interface for a period of three seconds or longer, and the client user expresses disinterest by holding the key for a period of less than three seconds. When the client user expresses disinterest, the database removes the candidate user profile or profiles associated with expressions of disinterest from the exposure list. The database stores a record of candidate user profiles associated with expressions of interest before removing those candidate user profiles associated with expressions of interest from the client user's exposure list.

The improvement disclosed herein may also be characterized as an electronic evaluation system within an online social network, the evaluation system stores a pre-recorded recording of a candidate user, which is accessible by a computing, device controlled by a client user. The client user's computing device is preferably configured to allow the client user to access and play back a plurality of recordings by a plurality of candidate users.

A database is configured to access and hierarchically organize the plurality of recordings, with the database further configured to retrieve a plurality of subscription lists associated with each of the plurality of recordings. The database hierarchically matches die plurality of subscription lists to subscription information of the client user, and is further configured to determine whether or not the client user has evaluated one of the plurality of recordings (the recordings selected from among audio, video, audio/visual, or any other type of recording method).

Each of the plurality of recordings may include a recording of a candidate user responding to a prompt generated by the online social network, such as answering a question. In response, the client user's computing device is configured to allow the client user to enter evaluation information for evaluating the recording at any time while the recording is playing on the computing device. Preferably the client user enters evaluation information by activating a key associated with the computing device for a predetermined period of time, and the computing device is configured to end playback of a recording upon the client user entering the evaluation information. The computing device may also be configured to present the client user with the next recording in hierarchical order upon entering evaluation information for the previous recording.

The improvement disclosed herein may also be characterized as a method of determining likelihood of exposure between any two users in, an online social network. The method includes the steps of allowing the two users of the social network to individually enter a user subscription list. The social network is configured to associate the two users with each other and allow them to share profile information. The two users each individually communicate a subscription list to the social network, which compares the subscription lists of the two users. The social network uses an algorithm to determine the likelihood of exposure between the two users based on predetermined criteria (i.e., the likelihood the two users should be exposed to each other's motile information based on affinity characteristics), and exposes the two users to each other.

In various embodiments, the two users may input their respective subscription lists by selecting from among a predetermined list of content creators. Alternatively the two users may input respective subscription lists by each transferring a list of content creators from an external website using an API, by each uploading a screenshot of a list of video content creators, or by typing in individual names of content creators. Additionally, each of the two users may be associated with a self-selected list of content creators in a database.

In one alternative embodiment, the improvement is a system wherein users within an electronic social network may evaluate one another wherein a candidate user allows access to a video feed of him or herself, the system consists of, one or more algorithms which determine the likelihood that a client user will he exposed to the video feed of the candidate user, a method for allowing a client user in the network to evaluate a candidate user based on a video feed of the candidate user, and a method for re-establishing a connection between a client user and a candidate user.

The video feed may be a video interview which was created using a process which includes prompting the first user with one or more questions from a database and may be created using a process which includes recording the candidate user as the candidate user responds to the questions. The video interview is preferably stored in a database upon completion for review by another user at a later time. The client user is shown the candidate user's video feed because of an algorithm which considers individual characteristics of both users, and the client user may choose to evaluate the video feed by expressing interest in the candidate user while the video feed is being played. Preferably the client user expresses interest in the candidate user by activating a single computer key for a pre-defined duration. Alternatively, the client user may express interest in the candidate user by activating a plurality of computer keys.

The connection between the client user and the candidate user is re-established via a text-based chat if the users express mutual interest in one another. Alternatively the connection between the client user and the candidate user is re-established by a real-time video call if the users express mutual interest in one another. The client user may choose to evaluate the video interview by expressing interest after playback of the video feed has concluded. In such a case the client user evaluates the video teed by activating a single computer key or a plurality of computer keys.

The electronic social network may be an online dating system which exists for the purpose of establishing a romantic relationship between the client user and the candidate user, Alternatively it may exist for the purpose of establishing a professional relationship between a client user and a candidate user. Thus, the client user may express interest in the candidate user on the basis of romantic attraction or on the basis of professional aptitude. The client user may evaluate the candidate user on the basis of an audio recording of the video interview, or on the basis of real-time or live video and/or audio.

In another alternative embodiment, an electronic evaluation system within an online social network consists of pre-recorded footage of a candidate user to be evaluated, a client user with the ability to evaluate the candidate user, and a method for determining whether or not the client user has evaluated the candidate user. The pre-recorded footage may consist of one or more audio and/or visual recordings of answers to one, or more questions which have been posed to, the candidate by the online social network. The client user may evaluate the candidate user at any time during the duration of the footage, and may evaluate the candidate user by activating a single computer key for a pre-defined duration.

The method includes an algorithm which is based on the amount of time the client user chooses to activate a single computer key. An evaluation leads to ending of the footage playback and leads to the client user being presented with new footage of a new candidate user. The algorithm is based on activation of a single computer key, or based on activation of a plurality of computer keys. Preferably the online social network exists for the purpose of establishing a romantic relationship between a client user and a candidate user, wherein the client user expresses interest in the candidate on the basis of romantic attraction. Alternatively the client user may evaluate the candidate user on the basis of professional aptitude. Thus, the online social network may exists for the purpose of establishing a professional relationship between the client user and the candidate user.

In another alternative embodiment, a method of determining likelihood of exposure between any two users in an online social network, consists of a method of allowing users in a network to enter a subscription list, two users on the network with potential of being exposed to one another, and an algorithm to determine the likelihood of the two users being exposed to one another. The users may input their subscription lists by selecting from a pre-defined list of content creators, transferring a list of content creators from an external website using an API, uploading a screenshot of a list of video content creators, or typing in names of content creators individually.

The two users are each associated with a self-selected list of content creators in a database, and the algorithm utilizes a comparison of the subscription lists to one another. The algorithm is used to determine the likelihood of exposure between the two users, wherein the exposure is for the purpose of establishing a romantic relationship between the two users, or alternatively, for the purpose of establishing a professional relationship between the two users.

### BRIEF DESCRIPTION OF THE FIGURES

FIG. 1 illustrates a flow-chart diagram of a preferred embodiment method for conducting a video interview according to the present invention;

FIG. 2 illustrates a flow-chart diagram of the method including determining exposure between two users;

FIG. 3 illustrates a flow-chart diagram of the method including conducting a discovery game;

FIG. 4 illustrates a flow-chart diagram of the method including determining the specific video interviews a Client User views in the Discovery Game;

FIG. 5 illustrates a user interface of the Discovery Game which allows one user of the presently described social network to be exposed to another user; and

FIG. 6 illustrates a user interface for a video interview system.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Broadly defined, a system is disclosed featuring an online social network, primarily for enabling users to connect for purposes of dating and forming relationships. In a primary embodiment of the method, each user records a video interview. The individual video interviews are then shown to other users in the network for the purpose of establishing romantic interest. If two users express mutual interest in each other based on their video interviews, the network establishes a text-based dialogue between the two users who may explore possibilities for further engagement beyond the scope of the online social, network.

The following definitions apply to the terms used herein to describe the system

Online social network; a network of individual users who are able to interact with one another over the Internet, using internet-connected computing devices, according to a specified set of parameters.

User: any individual person using an Internet-connected computing device for the purpose of engaging with other users on the presently described online dating system.

Population of users (ref no. 999): a group of users encompassing all users of the online social network described herein.

Client user: any user of the social network who is, at the time, engaging with the network for the purpose of discovering other users.

Candidate user: any user of the presently described social network who is in a position to be discovered by a client user of the presently described social network.

Client user's video interview (ref no. 107): the recorded video footage in which a client user is depicted responding to one or more questions.

Candidate user's video interview (ref no. 108): the recorded video footage which depicts a candidate user responding to one or more questions.

Discovery game (ref. no. 109): a method allowing one user of the presently described social network to be exposed to another user of the presently described social network.

Expression of interest: an action taken by a user indicating, an affinity with another user of the presently described social network.

Expression of disinterest: an action taken by a user indicating a lack of affinity with another user of the presently described social network.

Evaluate: an indication by a client user of either interest or disinterest in a candidate user based upon an audio and/or video feed which depicts the candidate user.

Footage: pre-recorded audio and/or visual footage of a client user or a candidate user of the presently described social network.

Exposure: an occurrence in which a client user of the presently described social network is provided biographical account information of another user.

Content creator: producer of audio and/or visual or text-based media.

Subscription list: a list of media content creators which is associated with a particular user on the presently described social network, and which may be representative of the client user or candidate user's taste in content creators.

YouTube® subscription list: a list wherein each item corresponds to an association between a YouTube® channel and a particular user of the presently described social network has indicated interest.

Subject: any user who is in a position to be the target of the expressed interest or disinterest of another user within the presently described online dating system.

Video interview: the process of posing questions to a particular user of the presently described online social network while conducting an audio and/or visual recording the user's responses to the questions.

Questions: audio and/or visual and/or text-based stimuli which are posed to a user for the purpose of eliciting a response from the user.

Text-based chat: a private text-based dialogue between any users within the presently described online social network.

Video content creator: a creator of web-based video content on social media platforms such as YouTube®.

Computer key: a binary physical and/or virtual button which a user chooses to activate at the user's discretion.

Video footage: a stored audio and/or visual recording of a user.

Video feed: audio-visual footage of a user.

Relationship: Any form of direct communication between two users of the presently described online social network.

Interest: the direct result of a positive or favorable impression.

Disinterest: the direct result of a negative or unfavorable impression.

The terms used herein having been defined, the specific steps and aspects of preferred embodiments of the system and method will now be discussed.

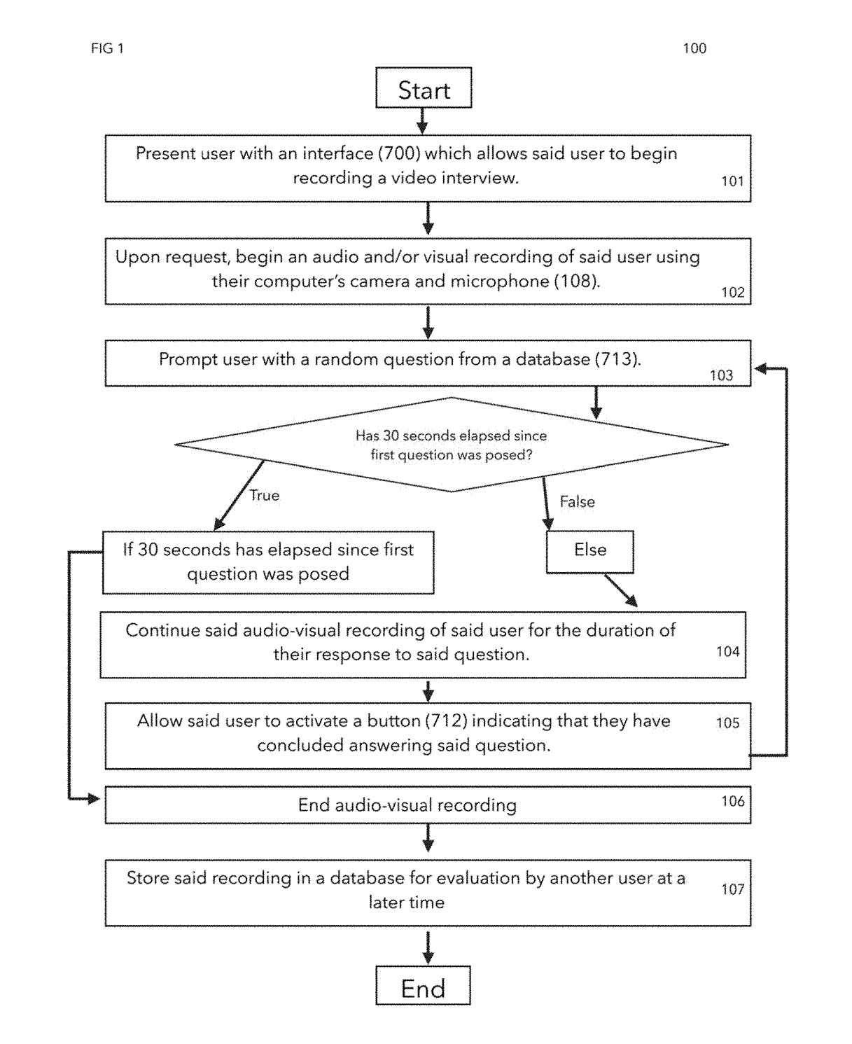

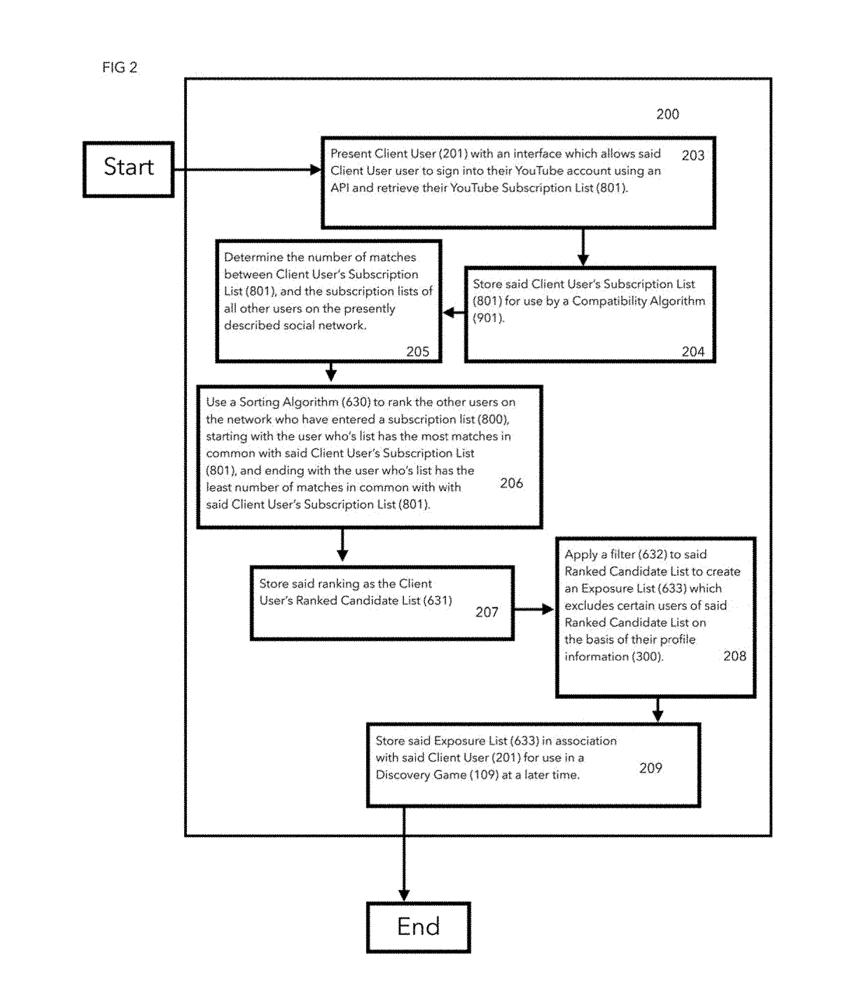

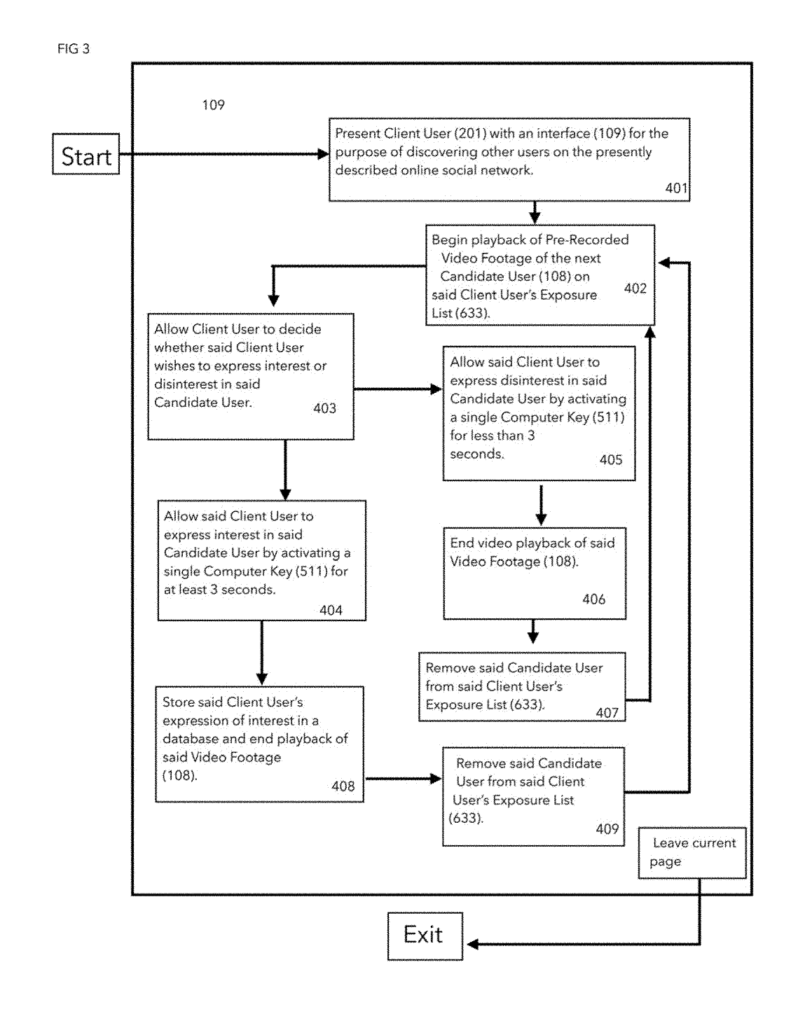

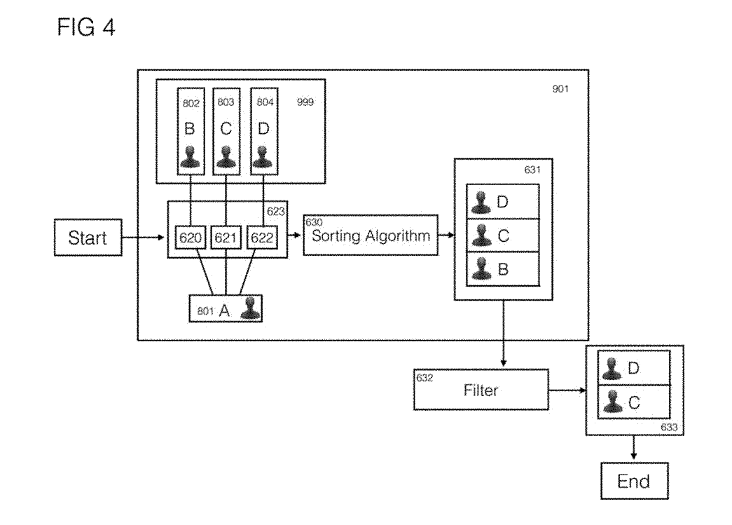

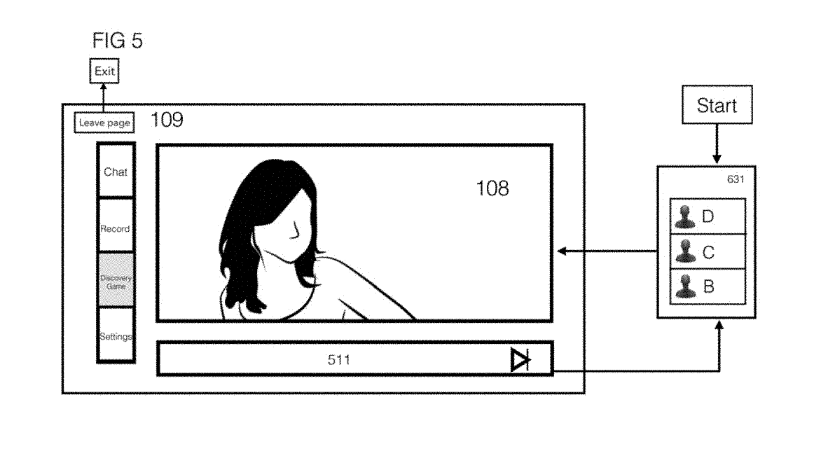

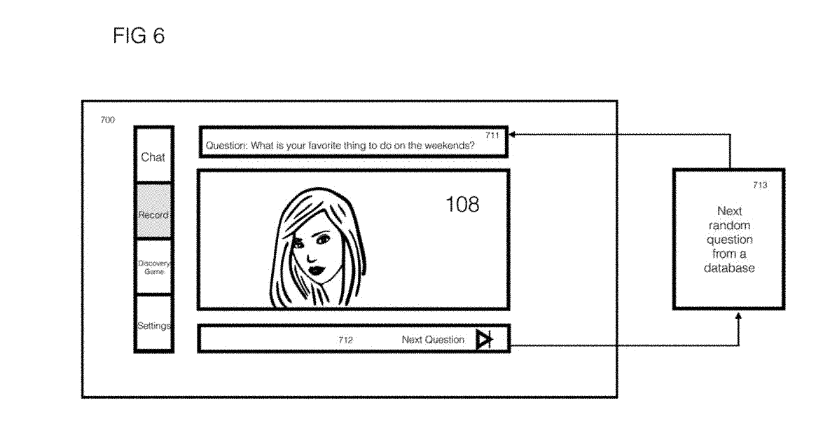

Referring to FIGS. 1-6, in a primary embodiment of the system and method, a client user 201 joins the presently described social network. for the purpose of discovering a candidate user 202 with whom to establish a relationship. The client user and the candidate user are both users, and are both members of the total population of users 999 who each have accounts on the network. The present invention is one method of establishing a relationship between any two members of the population of users 999.

The client user registers an account on the network by inputting profile information 300, which may include but is not limited to the client user's age, location, gender, sexual orientation, account username, account password.

The client user may also input a list of content creators from an online media website, such as YouTube®. The client user may also input a list of YouTube® content creators 801 in association with the client user's account on the presently described social network,

One method of allowing a client user to input their list of YouTube® content creators 801 may utilize an API from YouTube®. The API allows a client user to retrieve the list of content creators 801 by signing into their YouTube® account using an interface which exists within the presently described online network.

Once inputted, the client user's list of YouTube® content creators 801 may be stored in a database, for use by a compatibility algorithm 901 at a later time.

After successfully inputting the previously described list of YouTube content creators 801, the client user may participate in a video interview system 100 which may utilize a camera, a microphone, and a computer key 712 to record a video of the client user responding to a series of random questions from a database. That recording may automatically end after a predefined period of time, such as 30 seconds, for example. During the recording period, the client user may be prompted with a random question 713, and then be allowed to answer the question, before then pressing a computer key 712 to indicate that the client user has completed their answer.

The presently described process of asking and answering questions continues until the predetermined period of time (or another predetermined period of time) has elapsed since the first question was posed to the client user. After the client user's video has been recorded, the video interviewing system 100 ends, and the video recording of the client user 107 is stored in a database for review by another user of the network at a later time.

For the purpose of facilitating the establishment of a personal relationship between a candidate user 202 and a client user, the client user participates in a discovery game 109 in which the client user indicates interest or disinterest in the candidate user 108.

The discovery game 109 presents the client user with video playback of the video interviews of other members of the population of users 999. The video interviews of other members of the population have been recorded according to the methods of the video interview system 100. While viewing the video footage, the client user may choose to express either interest or disinterest in the user who's video interview is being played. After an indication of either interest or disinterest is made according to the presently described method, the indication of interest or disinterest is stored for use at a later time. After the indication is stored, the video footage stops playing and the video interview of another member of the population 999 begins playing immediately.

In the presently described discovery game, the client user 201 may be presented with the video interview 108 of a candidate user 202. As a member, of the total population of users on the network 999, the candidate user's video interview may be played because the candidate user reached a position of “rank 1” on the client user's exposure list 633.

The order of users which appear on the client user's exposure list 633 is determined in part by a compatibility algorithm 901, which compares the client user's subscription list 801 with the subscription lists of other users on the network. The compatibility algorithm works by first determining the number of matches 995 between the client user's list 633 and the lists of each other member of the population 999. The compatibility algorithm records, in a database, one match number 995 for every other member of the population, to represent their compatibility with the client user. That database, which is comprised of an array of match numbers, is called a match list 623.

The compatibility algorithm may invoke a sorting algorithm 630 to generate the client user's ranked candidate list 631 in which each match number may be rank-ordered from highest to lowest. The position of “rank 1” on the list in one embodiment may be occupied by a candidate user because the candidate user's subscription list 802 has more matches in common with the client user's subscription list 801 than does the subscription list of any other user on the network.

A filter may he applied to the client user's ranked candidate list 631 which disqualifies certain members of the, list on the basis of their profile information 300. The client user's exposure list 633 is derived from the presently described disqualification process. The exposure list 633 determines the order in which video interviews are shown in the discovery game 109, and consequently determines the time when the candidate user's video interview 108 is shown to the client user 201.

Once the client User 201 is shown video playback of the candidate user 202 in the discovery game 109, the client user may choose to express interest in the candidate user by activating a computer key 511 for a duration of at least 3 seconds, or some other predefined amount of time. The client user may alternatively choose to express disinterest in the candidate user by activating a computer key 511 for a duration of less than 3 seconds, or sonic other predefined amount of time, The indication of either interest or disinterest is stored,

Upon storing the indication of interest by the client user, the presently described social networking system may determine it the candidate user has expressed interest in the client user. If the candidate user and the client user have expressed mutual interest in one another through the methods of the presently described discovery game 109, the presently described social network sets up a two-way text-based chat dialogue 980 between the client user and the candidate user. The dialogue may expire and end after a predefined duration. In one embodiment, the client user can express a third level of interest (for example a medium level of interest) by holding a key associated with the interface for a third predetermined period of time. The dialogue exists for the purpose of facilitating the development of a relationship between the client user and the candidate user. Upon establishing the dialogue between the client user and the candidate user, the candidate user may be removed from the client user's exposure list 633. After ending the video playback, another playback begins of a video interview of the candidate user now occupying the “rank 1” position in the client user's exposure list 633.

Each new relationship which is formed between users within the network occurs according to the presently described method of invention.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for enabling users on an electronic social network to evaluate other users, comprising the steps of:
a plurality of candidate users individually creating a plurality of candidate user profiles, and individually recording a plurality of candidate user recordings, wherein each candidate user recording corresponds to one of the plurality of candidate user profiles;
providing a database, the database storing the plurality of candidate user profiles and corresponding recordings;
a client user interlacing with a computing device in communication with the database, the client user causing the database to access an online. client user media account, the client user media account including a client user subscription list;
providing a plurality of candidate user subscription lists, each of the plurality of candidate user subscription lists associated with a candidate use;
the database accessing the plurality of candidate user subscription lists, comparing the client user subscription list with the plurality of candidate user subscription lists, and creating a sorted hierarchical list of the plurality of candidate user subscription lists ordered from a largest number of matches to a smallest number of matches;
the database applying a filter to the hierarchical list, the filter identifying candidate user profiles for removal based on a predetermined criteria to create an exposure list; and
the database storing the exposure list for access by the client user using the computing device.

2. The method of claim 1 further comprising the step of presenting the client user with an interface on the computing device for displaying the recordings.

3. The method of claim 2 further comprising the step of playing back the first recording in the exposure list.

4. The method of claim 3 further comprising the step of the client user engaging the computing device to access the exposure list and express interest or disinterest using the interface.

5. The method of claim 4 wherein the client user expresses interest by holding a key associated with the interface for a period of three seconds or longer, and the client user expresses disinterest by holding the key for a period of less than three seconds.

6. The method of claim 4 wherein the client user expresses a third level of interest by holding a key associated with the interface for a third predetermined period of time. The method of claim 5 further comprising the step of the database removing candidate user profiles associated with an expression of disinterest from the exposure list.

8. The method of claim 7 further comprising the step of the database storing candidate user profiles associated with expressions of interest and removing candidate user profiles associated with expressions of interest from the client user's exposure list.

9. An electronic evaluation system within an online social network, comprising:
a pre-recorded recording of a candidate user, the recording accessible by a computing device controlled by a client user;
the computing device configured to allow the client user to access and play back a plurality of recordings of a plurality of candidate users;
a database configured to access and hierarchically organize the plurality of recordings, the database further configured to retrieve a plurality of subscription lists associated with each of the plurality of recordings, and hierarchically match the plurality of subscription lists to subscription information of the client user;
the database further configured to determine whether or not the client user has evaluated one of the plurality of recordings.

10. The system of claim 9, wherein the plurality of recordings comprises one or more recordings selected from among the list of audio, video, and audio/visual recordings.

11. The system of claim 9 wherein the plurality of recordings comprise a recording of the candidate user responding to a prompt generated by the online social network.

12. The system of claim 9, wherein the computing device is configured such that the client user may enter evaluation information for evaluating the recording at any time while the recording, is playing on the computing device.

13. The system of claim 12, wherein the client user enters evaluation information by activating a key associated with the computing device for a predetermined period of time.

14. The system of claim 13, wherein the computing device is configured to end playback of a recording upon the client user entering the evaluation information.

15. The system of claim 14, wherein the computing device is configured to present the client user with a second recording upon entering evaluation information.

16. A method of determining likelihood of exposure between any two users in an online social network, comprising the steps of
allowing the two users of the social network to individually enter a user subscription list:
configuring the social network to associate the two users with each other and allow the two users to share profile information;
the two users individually communicating a subscription list to the social network;
the social network comparing the subscription lists of the two users:
providing the social network with an algorithm for determining: the likelihood of exposure between the two users based on predetermined criteria; and
the social network exposing the two users to each other.

17. The method of claim 16 further comprising the step of the two users inputting respective subscription lists by selecting from among a predetermined list of content creators.

18. The method of claim 16 further comprising the step of the two users inputting respective subscription lists by each transferring a list of content creators from an external website using an. API.

19. The method of claim 16 further comprising the step of the two users inputting respective subscription lists by each uploading a screenshot of a list of video content creators,

20. The method of claim 16 further comprising the step of the two users inputting respective subscription lists by typing in individual names of content creators.
